(19) United States
(12) Patent Application Publication
(10) Pub. No.: US 2016/0265984 A1
(43) Pub. Date: Sep. 15, 2016

(54) WIRELESS SENSORS, SYSTEMS, AND METHODS THEREOF

(71) Applicant: Purdue Research Foundation, West Lafayette, IN (US)

(72) Inventors: Dimitrios Peroulis, West Lafayette, IN (US); Nithin Raghunathan, West Lafayette, IN (US); Michael Todd Hall, West Lafayette, IN (US)

(73) Assignee: PURDUE RESEARCH FOUNDATION, West Lafayette, IN (US)

(21) Appl. No.: 15/069,926

(22) Filed: Mar. 14, 2016

Related U.S. Application Data
(60) Provisional application No. 62/132,546, filed on Mar. 13, 2015.

(51) Int. Cl. G01K 13/00; G01K 7/34; G08C 17/02; G01K 1/02; H04W 4/00; H04W 52/02

(52) U.S. Cl. CPC G01K 13/006; H04W 4/005; H04W 52/0229; G08C 17/02; G01K 1/024; G01K 7/34

(57) ABSTRACT

A sensor is provided that is capable of sensing a level of a parameter in an environment surrounding the sensor, wirelessly transmitting data regarding the level of the parameter to another device, and converting a wireless signal to a current and powering the sensors with the current. The sensor may measure capacitance data and transmit the data to a computer to be converted into temperature readings. The sensor may provide temperature readings from multiple locations within a container into which the sensor is placed.

### CROSS REFERENCE TO RELATED APPLICATIONS

The present patent application is related to and claims the priority benefit of U.S. Provisional Patent Application Ser. No. 62/132546, filed Mar. 13, 2015, the contents of which is hereby incorporated by reference in its entirety into the present disclosure.

### TECHNICAL FIELD

The present disclosure generally relates to sensors. More particularly, the present disclosure relates to a system of wireless sensors capable of providing a real-time temperature profile of an environment, such as a lyophilization process.

### BACKGROUND

Lyophilization (freeze drying) is a process that cools and heats a product in order to remove vapors and liquids from the product. This process is used in many industries including pharmaceutical, biotechnology, food, agricultural, as well as various other technology industries, with the U.S. pharmaceutical contract manufacturing market alone being valued at over $5.37 billion. Unfortunately, it can be difficult to monitor the temperatures within a lyophilization chamber to the degree desired by industry. Sensors currently available on the market are generally battery powered and very large, making them unusable for many conventional lyophilization chambers.

Accordingly, there is an ongoing desire for methods or devices suitable for monitoring temperatures within an environment, such as a lyophilization chamber.

### BRIEF DESCRIPTION OF THE DRAWINGS

In the following description and drawings, identical reference numerals have been used, where possible, to designate identical features that are common to the drawings.

FIG. 1 is a diagram showing a system for according to various aspects.

FIG. 2 is a illustration of a sample implementation of a sensing device according to one embodiment mounted in a pharmaceutical vial.

The attached drawings are for purposes of illustration and are not necessarily to scale.

### DETAILED DESCRIPTION

Throughout this description, some aspects are described in terms that would ordinarily be implemented as software programs. Those skilled in the art will readily recognize that the equivalent of such software can also be constructed in hardware, firmware, or micro-code. Because data-manipulation algorithms and systems are well known, the present description is directed in particular to algorithms and systems forming part of, or cooperating more directly with, systems and methods described herein. Other aspects of such algorithms and systems, and hardware or software for producing and otherwise processing signals or data involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

The present invention provides methods and systems for using wirelessly powered temperature sensors. The sensors are capable of retrieving and wirelessly transmitting data, and have the capability to be powered via a wireless signal. Each individual sensor may be configured to read multiple inputs on a single device while operating in a network of a plurality of other similar sensors. The sensors use a combination of commercially available integrated circuits and lumped elements in order to gather data and transmit this data to another device for analysis. The data is gathered from lumped elements via a chip on each sensor. Preferably, the sensor comprises a plurality of dielectric based sensing elements wherein the dielectric changes based on temperature, and the sensors are configured to measure capacitance data and transmit the data to a computer to be converted into temperature readings. Each sensor may accomplish all of this while preferably also having a very compact footprint relative to conventional sensors of comparable capabilities. With a multitude of these sensors working simultaneously, the system can provide a temperature profile of an environment such as, but not limited to, the interior of a lyophilization chamber for real-time observation of the lyophilization process.

According to one aspect of the disclosure, a sensor is provided that is capable of sensing a level of a parameter in an environment surrounding the sensor, wirelessly transmitting data regarding the level of the parameter to another device, and converting a wireless signal to a current and powering the sensors with the current. The sensor may measure capacitance data and transmit the data to a computer to be converted into temperature readings. The sensor may be configured to measure the parameter (e.g., temperature) at two or more locations on the sensor. Each sensor is capable of recording temperatures at multiple locations in a container into which the sensor is placed.

According to another aspect of the invention, a method of monitoring the temperature of an environment includes providing a plurality of sensors at locations within the environment, powering the plurality of sensors with a wireless signal, receiving capacitance data from each of the plurality of sensors, converting the capacitance data into temperature readings, and forming a temperature profile of the environment from the temperature readings.

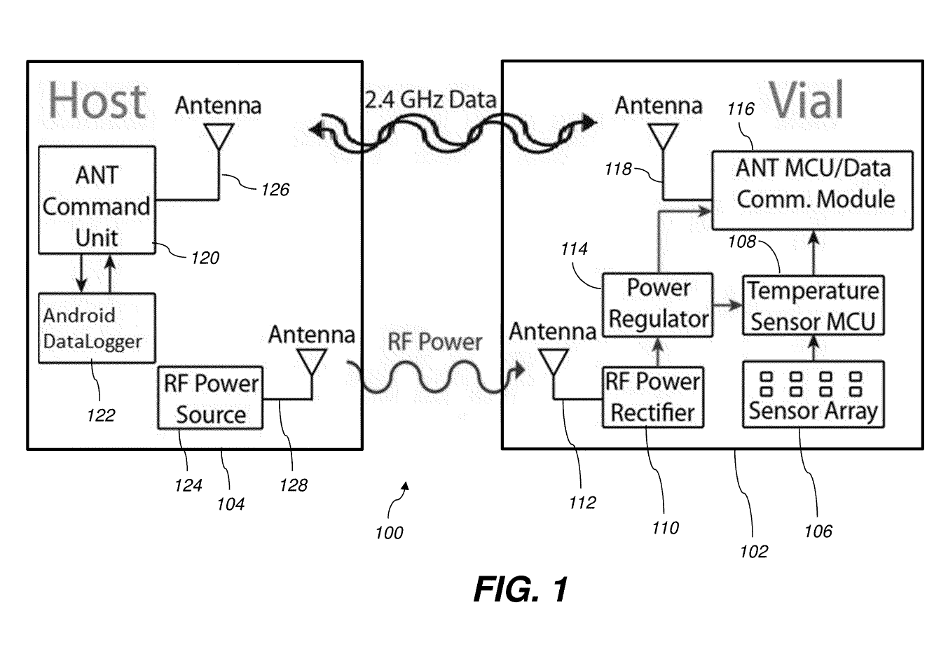

FIG. 1 shows a system 100 according to one embodiment of the disclosure. As shown, the system 100 includes a sensor device 102 and a host device 104. The sensor device may comprise a temperature sensor 106 (which may optionally comprise an array of temperature sensors), a temperature sensor microcontroller unit (MCU) 108, a radio frequency (RF) power rectifier 110 connected to an antenna 112, a power regulator 114, and a communication module 116 having an antenna 118.

The host device 104 may include a command unit 120, a data logging unit 122, an RF power source 124. Antennas 126 and 128 are connected to the command unit 120 and RF power source 124 respectively. In certain embodiments, the command unit 120 and communication module 116 may comprise an ANT or Bluetooth communication device, although other protocols may be used as well.

The temperature sensor 106 may comprise a capacitive sensor (or array of sensors) which are capable of sensing temperatures below 80 degrees Celsius at a resolution of less than 0.01 degrees Celsius. In certain embodiments, the sensor device 102 is encased or coated in a cryogenic material, such as a cryogenic epoxy.

The host device 104 may comprise a personal computer or computer server capable of processing and recording data received from the sensor device 102. The host device 104 may receive data from multiple sensor device 102, up to and including hundreds or thousands of sensor devices 102.

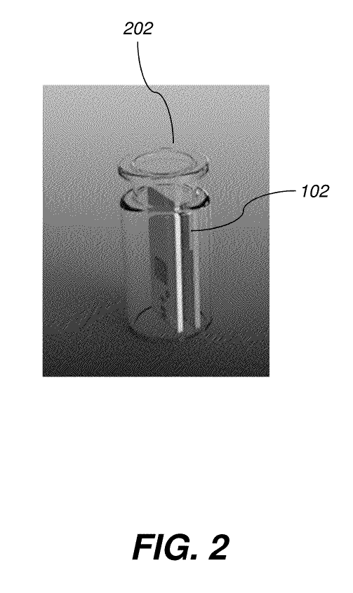

FIG. 2 shows an example rendering of the sensor device 102 placed within a pharmaceutical vial 202 which is commonly used to process medicine and other pharmaceutical products. In one example, the sensor 102 uses embedded system electronics based on low power 2.4 GHz wireless (i.e. ANT/Bluetooth 4.0) to measure upto 7 simultaneous capacitance data which is transmitted to a computer and then converted into temperature readings. The sensor 102 may be implemented on a single substrate (PCB) or in multi-board implementations.

In view of the above, it can be seen that a significant advantage of this invention is that accurate temperature profiles may be produced during a lyophilization process with wirelessly powered sensors that wirelessly transmit data for analysis.

Steps of various methods described herein can be performed in any order except when otherwise specified, or when data from an earlier step is used in a later step. Exemplary method(s) described herein are not limited to being carried out by components particularly identified in discussions of those methods.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Furthermore, various aspects herein may be embodied as computer program products including computer readable program code (“program code”) stored on a computer readable medium, e.g., a tangible non-transitory computer storage medium or a communication medium. A computer storage medium can include tangible storage units such as volatile memory, nonvolatile memory, or other persistent or auxiliary computer storage media, removable and non-removable computer storage media implemented in any method or technology for storage of information such as computer-readable instructions, data structures, program modules, or other data. A computer storage medium can be manufactured as is conventional for such articles, e.g., by pressing a CD-ROM or electronically writing data into a Flash memory. In contrast to computer storage media, communication media may embody computer-readable instructions, data structures, program modules, or other data in a modulated data signal, such as a carrier wave or other transmission mechanism. As defined herein, “computer storage media” do not include communication media. That is, computer storage media do not include communications media consisting solely of a modulated data signal, a carrier wave, or a propagated signal, per se.

The invention is inclusive of combinations of the aspects described herein. References to “a particular aspect” (or “embodiment” or “version”) and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless otherwise explicitly noted. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected within the spirit and scope of the invention.

1. A device comprising:
a sensor for sensing a level of a parameter in an environment surrounding the sensor, the sensor mounted to a substrate;
a wireless transmitter configured to transmit data regarding the level of the parameter to a device external to the sensor; and
an energy harvesting unit operatively connected to the sensor and the wireless transmitter, the energy harvesting unit configured to convert a wireless signal to energy for powering the wireless transmitter and the sensor; and
and antenna connected to the energy harvesting unit.

2. The device of claim 1, wherein the sensor measures capacitance data and transmits the data to a computer to be converted into temperature readings.

3. The device of claims 2, wherein sensor is configured to measure the parameter at two or more locations on the substrate.

4. The device of claim 1, wherein the energy harvesting unit comprises an RF power rectifier.

5. The device of claim 1, wherein the energy harvesting unit comprises an energy regulator.

6. The device of claim 3, wherein the sensor comprises a capacitive temperature sensor.

7. The device of claim 6, wherein the sensor comprises a plurality of capacitive temperature sensing elements.

8. The device of claim 6, wherein the sensor is configured to measure temperatures down to −80 degrees Celsius.

9. The device of claim 8, wherein the sensor has a resolution of less than 0.01 degrees Celsius.

10. The device of claim 3, wherein the energy harvesting unit is configured to harvest energy from wireless signals in the range between 300 MHz and 1 GHz.

11. The device of claim 3, wherein the device is incased in a temperature conducting cryogenic epoxy.

12. The device of claim 3, wherein the device is configured to fit within a pharmaceutical vial.

13. The device of claim 3, wherein the sensor comprises plurality of sensors in an array.
